(19) United States
(12) Patent Application Publication
(10) Pub. No.: US 2024/0380505 A1
(43) Pub. Date: Nov. 14, 2024

(54) DYNAMIC TRAFFIC LOAD COMPENSATION

(71) Applicant: Net Insight AB, Solna (SE)

(72) Inventors: Magnus DANIELSSON, Stocksund (SE); Per LINDGREN, Strängnäs (SE)

(73) Assignee: Net Insight AB, Solna (SE)

(21) Appl. No.: 18/696,161

(22) PCT Filed: Sep. 29, 2022
(86) PCT No.: PCT/EP2022/077165

§ 371 Date: Mar. 27, 2024

(30) Foreign Application Priority Data
Oct. 1, 2021 (SE) 2151209-0

(51) Int. Cl. H04J 3/06; H04L 47/28; H04W 56/00

(52) U.S. Cl. CPC H04J 3/0658; H04L 47/28; H04W 56/004

(57) ABSTRACT

The present invention relates to methods for enabling enhanced timing recovery between a first node and a second node in a network, the method comprising transmitting a plurality of packets from a first node to a second node, performing time transfer between the first node and the second node to obtain a first compensation factor, the first compensation factor being a mean value of a first sequence of min samples from a first min distribution, obtaining a second compensation factor, the second compensation factor being determined as i) a mean value of a second sequence of min samples from a second min distribution, the second min distribution being obtained by subtracting the mean value of the first sequence of min samples from the respective min samples of the first sequence of min samples, or ii) a rate of change of the mean value of the first sequence of min samples between a first and second block of packets, and enabling enhanced time recovery between the first and the second node by using the second compensation factor as a time recovery module.

### TECHNICAL FIELD

The present invention relates to the field of signal transmission. More particularly, methods, nodes and systems for enhanced time transfer and time recovery in a network is proposed, where a dynamic compensation model depending on the traffic load is proposed.

### BACKGROUND OF THE INVENTION

Time transfer in a network, such as for network synchronization (synchronization between nodes in a network), is essential for the function of a network. For example, many networks, such as packet based networks, require frequency and time synchronization (phase alignment) between nodes for successful operation and packet transfer, and many applications and services require the network to distribute accurate time and frequency to their nodes, such as mobile base stations, radio and TV transmitters, sensors, etc., operators may also provide synchronization services to their customers for use in their applications in for example servers or machines, or in self-driving cars.

The task of network synchronization is to distribute a reference signal from the primary reference clock (PRC) to all network elements requiring synchronization. The method used for propagating the reference signal in the network is usually the master-slave method, a.k.a. controller-responder, primary-replica, and leader-follower methods, a hierarchical model where the slave clock must be slaved to (must respond to) a clock of higher (or equal) stability. Synchronization information is transmitted through the network via synchronization network connections. Synchronization network connections typically are unidirectional and generally point-to-multipoint. A centralized timing network architecture may be used, or a distributed timing network architecture (e.g. using Global Navigation Satellite System, GNSS).

Synchronization measurements may include phase measurements in view of reference signals, phase deviation and analysis of the phase time interval error, fractional frequency offset, maximum time interval error (MTIE) and time deviation (TDEV).

Time (relative and absolute) and frequency transfer describes mechanisms for comparing measurements of time and frequency from one location to another. Time transfer is a scheme where multiple sites share a precise reference time. Multiple techniques have been developed, often transferring reference clock synchronization from one point to another, often over long distances. Time transfer may be used for time synchronization between different entities or nodes in a network, which is essential for the function of the network. Packet based frequency distribution from a reference clock to a recovered clock comprises the steps generation from signal to packet, transfer including packet transmission over packet network, recovery from packet to signal.

A GNSS, or Global Navigation Satellite System, is a generic name for a group of artificial satellites that send position and timing data from their high orbits. The global positioning system, GPS, is just one of the many different sets of satellites that can provide such data. GPS (or GNSS) satellites include three or four atomic clocks that are monitored and controlled to be highly synchronized and traceable to national and international standards (known as UTC). So, for time synchronization, the GPS signal is received, processed by a local “master” clock, time server, or primary reference, and passed on (distributed) to “slaves” and other devices, systems, or networks so their local clocks are likewise synchronized to UTC. Thus, synchronization may be achieved using e.g., global positioning systems, e.g. by installing GPS receivers at transmitter sites. GPS receivers, however, may be easily intentionally or unintentionally jammed, or fail for other reasons such as equipment failure, and represent an additional cost in the network in terms of equipment and supervision. Further, the foreign control of the system may be an issue of concern, such as the military control of some GNSS systems, due to the dual use of government/military and civilian use.

Techniques for time synchronization of network nodes without utilization of GPS includes, for example, the network time protocol (NTP), which may be used to synchronize the clocks of network nodes to a master node or a reference clock using time stamps. The Precision Time Protocol (PTP) is a protocol used to synchronize clocks throughout a computer network, also known as IEEE 1588. IEEE 1588-2019 includes a profile concept, a.k.a. default profile or standard profile, defining PTP operating parameters and options. Several profiles have been defined for applications including telecommunications, electric power distribution and audio-visual. The earlier IEEE 1588-2008 introduced a clock associated with network equipment used to convey PTP messages. There are five basic types of PTP devices (“clocks”); ordinary clock (master or slave), boundary clock (“master and slave”), end-to-end transparent clock, peer-to-peer transparent clock and management node. All five types implement one or more aspects of the PTP protocol. The transparent clock modifies PTP messages as they pass through the device. Timestamps in the messages are corrected for time spent traversing the network equipment. This scheme improves distribution accuracy by compensating for delivery variability across the network. PTP messages may use the User Datagram Protocol over Internet Protocol (UDP/IP) for transport.

For packed-based transmissions, the impairment of the timing of received packets is due to the packet network that transports them. Since the network is realized based on an ideal situation, while actual dynamic variations when operating in the network may affect the outcome of the packet transfer. Increased traffic load may lead to increased packet delay, may increase the packet based variations, jitter, and packet loss may occur. Thus, improved methods for compensating jitter due to traffic load changes are needed.

### SUMMARY OF THE INVENTION

An object of the present disclosure is to provide methods and devices which seek to mitigate, alleviate, or eliminate the above-identified deficiencies in the art and disadvantages singly or in any combination.

This object is obtained by a method in a first node for enabling enhanced time recovery between the first node and a second node in a network, the method comprising transmitting, to the second node, a plurality of packets comprising a timestamp t1, the timestamp t1 relating to a time when a respective packet was transmitted in relation to a local clock in the first node, receiving, from the second node, traffic load information, and transmitting, to the second node, a time recovery parameter based on the traffic load information, and optionally performing time recovery of the local clock of the second node using the time recovery parameter.

The second node splits the plurality of packets into a sequence of blocks of packets and, for each of the plurality of packets, timestamps it with a timestamp t2, the timestamp t2 relating to a time when a respective packet was received in relation to a local clock in the second node.

The time recovery parameter may be estimated based on the mean delay, the mean value of the second sequence of min samples from the second min distribution, or a rate of change of the mean value of the mean value between a first and second block of packets.

In one aspect, the time recovery parameter may be attained by determining time differences between the timestamps t2 and t1 for each packet in each block of packets to obtain a delay for each packet, performing min processing on each of the blocks of packets to estimate, for each block of packets, a first min distribution of the delays for each packet to obtain a first sequence of min samples, estimating a mean value of the first sequence of min samples from the first min distribution, estimating a second min distribution by subtracting the mean value of the first sequence of min samples from the respective min samples of the first sequence of min samples to obtain a second sequence of min samples, estimating the time recovery parameter as the mean delay, the mean delay being determined as the mean value of the second sequence of min samples from the second min distribution. The steps may either be performed in the first or second node, where the second node transmits traffic load information to the first node, which, depending on how many of the steps that are to be carried out in the first node, comprises different information. In one embodiment, most of the steps are carried out in the second node and the traffic load information comprises information, which may comprise how the second node has split the plurality of packets into a sequence of blocks of packets and a second sequence of min samples, the second sequence of min samples being estimated by deducting a mean value of a first sequence of min samples from a first min distribution, first sequence of min samples being obtained by min processing on each of the blocks of packets to estimate, for each block of packets, a first min distribution of the delays for each packet. In another embodiment, the second node just sends the timestamp and block information to the first node, which performs the steps to attain the time recovery parameter.

In a further aspect, the time recovery parameter may be determined as a rate of change of the mean value between a first and second block of packets, for example by determining time differences between the timestamps t2 and t1 for each packet in each block of packets to obtain a delay for each packet, performing min processing on each of the blocks of packets to estimate, for each block of packets, a min distribution of the delays for each packet to obtain a sequence of min samples, and estimating, for each block of packets, a mean value of the sequence of min samples from the min distribution, wherein the rate of change is calculated as C_rate=(mean2−mean1)/(inter block time), wherein C_rate is the rate of change, mean2 is the mean value of the second block of packets and the mean1 is the mean value of the first block of packets, and inter block time is the time periodicity between the blocks.

In some aspects are systems and nodes carrying out the above methods provided.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, where the same reference numerals will be used for similar elements, wherein:

FIG. 1 illustrates time transfer over a packet network (100).

FIG. 2 is an illustration of a clock synchronization using PTP messages including an exchange of four timestamps between a reference clock and the clock to be synchronized.

FIG. 3 illustrates a theoretical background of the invention, where FIG. 3A depicts a histogram to illustrate the shape of the distribution of the time-differences between two nodes formed as a statistical distribution. FIG. 3B is a histogram illustrating the distribution of the packages after min-delay filtering or lucky packet filtering, illustrating how to make a selection of a delay of a packet in a block of packets. FIG. 3C depicts the distribution in FIG. 3B taking the approximate form of a right-angled triangle.

FIGS. 4A and 4B are block diagrams of a first and second node of the invention, respectively.

FIG. 5 shows a flowchart of an exemplary method for achieving enhanced timing recovery according to an embodiment of the invention.

FIG. 6 shows a flowchart of an exemplary method for achieving enhanced timing recovery from the perspective of a first node.

FIG. 7 shows a flowchart of an exemplary method for achieving enhanced timing recovery from the perspective of a second node.

### DETAILED DESCRIPTION

Aspects of the present disclosure will be described more fully hereinafter with reference to the accompanying drawings. The apparatus and method disclosed herein can, however, be realized in many different forms and should not be construed as being limited to the aspects set forth herein. Like numbers in the drawings refer to like elements throughout.

The terminology used herein is for the purpose of describing particular aspects of the disclosure only, and is not intended to limit the disclosure. As used herein, the singular forms “a”, “an” and “the” are intended to include the plural forms as well, unless the context clearly indicates otherwise.

In some embodiments a non-limiting term “node” or “network node” is used. It should be understood that this term refers to any type of node that may send and/or receive information, such as data and control information, over a network. A physical node is typically an electronic device that is attached to a network, and is capable of creating, receiving, or transmitting information over a communications channel. The node may be a data communication equipment (DCE) such as a modem, hub, bridge, router or switch, or data terminal equipment (DTE) such as a digital telephone handset, a printer, a server, or a host computer. In an example, the node may be a computer terminal connected to a network, such as a local area network (LAN), wide area network (WAN) or the Internet. In another example, a node may be synchronization equipment, such as a boundary clock or grandmaster connected to the network.

The term “network” refers to any type of network over which a network node may communicate, such as a local area network (LAN), wide area network (WAN) or the Internet. The network may use different network technologies such as Ethernet, SDH, SONET, PDH, ATM, DTM or IP. The network may be referred to as an Internet Protocol (IP) network, a communication network that uses IP to send and receive messages between one or more nodes or computers, which may be implemented in Internet networks, WAN, LAN and enterprise networks, for example. The service network may be used for mobile networks such as 2G/3G/4G/5G/6G networks, power networks, fntech network, or single frequency networks (SFN) or a media network including digital television (DTV) or a digital radio distribution network.

By “timing recovery”, “time recovery” or “clock recovery” is meant to recover a clock at the symbol rate or a multiple of the symbol rate from the modulated waveform. This clock is required to convert the continuous-time received signal into a discrete-time sequence of data symbols. In serial communication of digital data, clock recovery is the process of extracting timing information from a serial data stream to allow the receiving circuit to decode the transmitted symbols. Clock recovery from the data stream is expedited by modifying the transmitted data. Wherever a serial communication channel does not transmit the clock signal along with the data stream, the clock must be regenerated at the receiver, using the timing information from the data stream. Clock recovery is a common component of systems communicating over wires, optical fibers, or by radio.

The terms “IEEE 1588” and “Precision time protocol (PTP)” may be used interchangeably herein, and refers to a protocol used to synchronize clocks throughout a computer network.

The term “block” refers to a sequence of streamed packets being transmitted between two nodes. The term “block size” refers to a number of packets contained in a block, i.e. the length of the sequence of packets. The “block rate” refers to a rate for which different blocks are being transmitted, i.e. how often a block (stream of packets) is being transmitted from a transmitter to a receiver. The term “packet rate” refers to the rate for which packets are being transmitted between a transmitter and a receiver, and depends both on the block size (number of packets per block) and block rate (number of block per time unit). In some cases, if the blocks are sent back to back and the packet rate relates to the rate that the blocks are sent, then the block rate is the packet rate divided by the block size. A “block time”, refers to the length of time that a block is transmitted, and an “inter block time” refers to a time periodicity between the blocks, which controls the periodicity or frequency of the blocks. In some aspects, the block time and the inter block time is the same. A packet may also be referred to as a “sample”, as a packet results in a sample (time stamp pair consisting of transmitting time stamp and receiving time stamp) when being transmitted to a receiver.

Network traffic or data traffic is the amount of data moving across a network at a given point of time. Network data in computer networks is mostly encapsulated in network packets, which provide the load in the network. The term “traffic load” or “packet load” as used herein may be used interchangeably, and refers to the amount of traffic, such as packets, being transmitted in a network, or for a specific link, at a specific time instance or time duration.

The term “traffic load information” refers to information regarding the present traffic load in the network, which can be estimated based on time transfer between a first and a second node, followed by min processing, as described in the methods of the present invention. The traffic load is estimated in a first node, and indicated to a second node. In some embodiments, a time recovery parameter is estimated based on the traffic load information, and transmitted to the second node for performing time recovery of the local clock of the second node using the time recovery parameter.

The traffic load information may comprise different information depending on in which node the respective steps of the method are performed. After time transfer between the first node and the second node, the respective steps of determining time differences between the timestamps for each packet, performing min processing to obtain a sequence of min samples, estimating a mean value of the first sequence of min samples, estimating a second min distribution and estimating the time recovery parameter as the mean delay, the mean delay being determined as the mean value of the second sequence of min samples from the second min distribution, may be performed in any of the first and the second node. Depending on how many of the steps that are performed in the second node, the traffic load information comprises different type of information. The common aspect of all these different traffic load information sent from the second node to the first node is that based on this information, the first node may perform the remaining steps (steps not performed in the second node of the above described steps) and estimate a time recovery parameter based on the traffic load information for enabling timing recovery of the local clock of the second node using the time recovery parameter. Network delay is a design and performance characteristic of a telecommunications network. It specifies the latency for a bit of data to travel across the network from one communication endpoint to another. It is typically measured in multiples or fractions of a second. Delay may differ slightly, depending on the location of the specific pair of communicating endpoints.

In computer networking, packet delay variation (PDV) is the difference in end-to-end one-way delay between selected packets in a flow with any lost packets being ignored. The effect is sometimes referred to as packet jitter. PDV hence relates to the variation between the individual delays of different (selected) packets in e.g. a transmitted stream of packets, such as a block. As traffic load increases, so does the PDV of a transmitted block of packets. Also changes in configuration, reroutes, firmware upgrades and other events may affect the PDV.

The “min algorithm”, also referred to as “min processing”, min-delay filtering” or “lucky packet filtering” is a non-linear filtering method which, when being employed to the time stamp differences of a block of packets being transmitted from one node to another, by weighing the differences differently based on their value, allows for selecting a better value, which is whatever value of two that has lower delay. Thus, by the “delay” or “delay estimate” in this respect is referred to the time differences between the received time stamps and the transmit time stamps. In one example, the algorithm basically compares two delay values and selects the lowest of the two, then proceeds with the rest of the values.

Thus, in the filtering method the minimum delay packet is chosen to represent the best measure out of that block. The delay of the minimum delay packet is referred to as the “min delay”. The delay comprises the “background delay” of the network and the “traffic based delay”, where selecting the minimal delay is selected the one with the least traffic based delay.

Thus, “min processing”, as used herein, refers to a non-linear filtering method which, allows for selecting the better value of two compared values, which is whatever value of the two that has lower delay. By min processing all packets in a block, the best value, having the lowest delay, may be selected for each block, which value/corresponding packet is referred to as the “min sample” or “min delay”. Thus, by comparing all delays of all packets (samples) two-by-two and selecting the better value each time until all packets in a block has been processed, the sample with the lowest delay may be found. The order of processing the packets does not matter, it may be done sequentially or in any order an implementor may see fit, as any order will result in the better value being selected, as it will always be selected as the lowest delay sample out of two compared values. Thus, in the filtering method the minimum delay packet, the min sample, is chosen to represent the best measure out of that block. Thus, the min processing give rise to a number of min samples from a sequence of blocks, one min sample per block, which form a sequence of min samples.

Accordingly, min processing selects a packet from each block having a lowest delay as a min sample of said block and wherein the min samples of all blocks in the sequence of blocks form a sequence of min samples. Thus, comparing all values to select the lowest delay is performed by min processing on each of the blocks of packets. The min processing yields a distribution of min samples, referred to as a “min distribution”. Thus, min processing is performed to estimate, for each block of packets, a first min distribution of the delays for each packet to obtain a first sequence of min samples. By selecting the packet having the lowest delay as the min sample for said block, a sequence of min samples for all blocks can be obtained, which is a collection of min delays/samples for each block obtained from the min processing. The (statistical) distribution of said min samples is the “min distribution”. A min sequence (sequence of min samples) can be achieved using either non-overlapping or overlapping blocks of samples, from an original set of measures. For non-overlapping blocks, there is no two block with common samples evaluating, whereas for overlapping blocks, later samples are used in subsequent block(s). The same min (sample) processing is performed for each block regardless of the processing is non-overlapping or overlapping. The overlapping block processing produce a higher rate of min samples than non-overlapping blocks. With a ¾ overlap of blocks, each sample can contribute in 4 blocks and the min sample series provide 4 times higher update rate than the non-overlapping processing.

In e.g. telecommunications, the Round Trip Delay (RTD) or Round Trip Time (RTT) is the length of time it takes for a signal to be sent plus the length of time it takes for an acknowledgement of that signal to be received. This time delay includes the propagation times for the paths between the two communication endpoints. In the context of computer networks, the signal is generally a data packet, and the RTT is also known as the ping time. An internet user can determine the RTT by using the ping command. End-to-end delay is the length of time it takes for a signal to travel in one direction and is often approximated by half the RTT.

Time (relative and absolute) and frequency transfer describes mechanisms for comparing measurements of time and frequency from one location to another. Frequency transfer may be performed using either physical layer options (SONET/SDH, SDSL, GPON, Synchronous Ethernet) or packet-based options (SATOP, CESoPSN, NTP, PTP). Using the packet-based option have several benefits, such as flexibility, simple in theory and applicable to both frequency and time, while the drawbacks are the complexity of the network and the network traffic, which make real life implementation not as easy as the ideal theoretical case. For example, the shifting traffic load greatly impact the outcome.

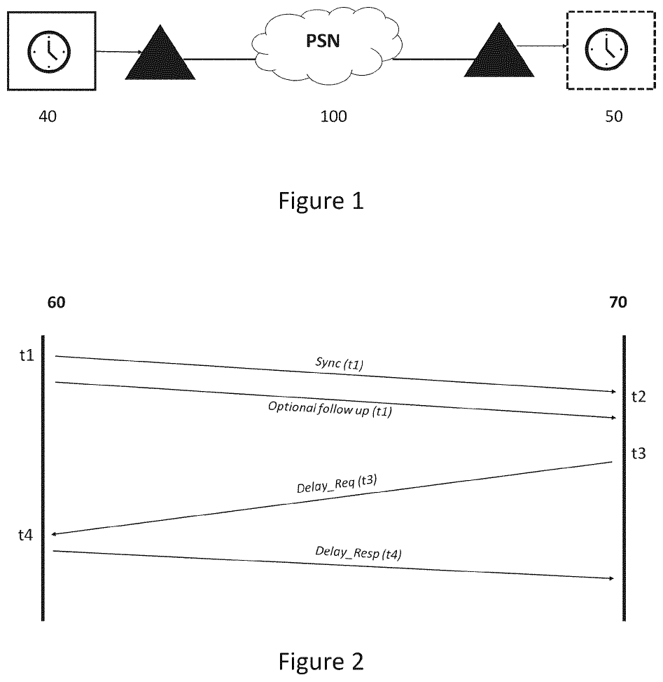

FIG. 1 illustrates time transfer over a packet switched network, PSN (100). A signal from a node with a reference clock 40 is used for generation from signal to packet, transferred as a packet transmission over a packet network, 100, and recovered from packet to signal for recovery of the recovered clock, 50, of the receiver node.

The ITU Telecommunication Standardization Sector (ITU-T) coordinates standards for telecommunications and Information Communication Technology. ITU-T The main products of ITU-T are Recommendations (ITU-T Recs)-standards defining how telecommunication networks operate and interwork. Study group 15 (SG15) Question 13 (Q13) have developed recommendations for packet based timing, such as Recommendation ITU-T G.781.1 which specifies a functional architecture model and corresponding atomic functions for the transport of time and frequency synchronization over packet-based networks, and Recommendation ITU-T G.8261/Y.1361, which defines frequency synchronization aspects in packet networks including the adaptive clock recovery definition: “In this case the timing recovery process is based on the (inter-) arrival time of the packets (e.g., timestamps or circuit emulation service (CES) packets). The information carried by the packets could be used to support this operation. Two-way or one-way protocols can be used.” It specifies the maximum network limits of jitter and wander that shall not be exceeded. It specifies the minimum equipment tolerance to jitter and wander that shall be provided at the boundary of these packet networks at TDM and synchronization interfaces. It also outlines the minimum requirements for the synchronization function of network elements. The requirements for the jitter and wander characteristics that are specified in the Recommendation must be adhered to in order to ensure interoperability of equipment produced by different manufacturers and a satisfactory network performance.

Time transfer is a scheme where multiple sites share a precise reference time. In a one-way time transfer system, one end transmits its current time over some communication channel to one or more receivers. The advantage of one-way systems is that they can be technically simple and serve many receivers, as the transmitter is unaware of the receivers. The principal drawback of the one-way time transfer system is that propagation delays of the communication channel remain uncompensated except in some advanced systems.

In a two-way time transfer system, the two peers will both transmit, and will also receive each other's messages, thus performing two one-way time transfers to determine the difference between the remote clock and the local clock. The sum of these time differences is the Round Trip Delay between the two nodes. It is often assumed that this delay is evenly distributed between the directions between the peers. Under this assumption, half the Round Trip Delay is the propagation delay to be compensated. A drawback is that the two-way propagation delay must be measured and used to calculate a delay correction. To calculate delays and determine compensation, information such as time stamps, time difference measurements, correction factors, and various statistics between nodes involved in two-way time transfer needs to be available. The two-way time transfer mechanism is the basis of all packet time transfer protocols, such as NTP and IEEE 1588 (PTP). They generally assume path symmetry and path consistency, although IEEE 1588 has the concept of asymmetry correction. However, the correction values are not dynamically measured—they need to be statically configured.

IEEE/PTP, a protocol that distributes frequency, phase and time over packet based network, has become the standard for distribution of high accuracy time. Following guidelines for specific network architectures allows the delivery of time to accuracies of one microsecond. This level of accuracy is required for mobile base stations using either Time Division Duplex technology and/or advanced LTE functions, as well as in the power industry for intelligent electronic device alignment. More lenient architectures can still achieve 100 microseconds or better accuracies which can greatly enhance the usefulness of event logging and network one way delay measurements. In addition, 1588 has been used to deliver a frequency reference for T1/E1 ports or for mobile base station frequency alignment. This is useful in environments where the transport network does not provide physical layer synchronization services.

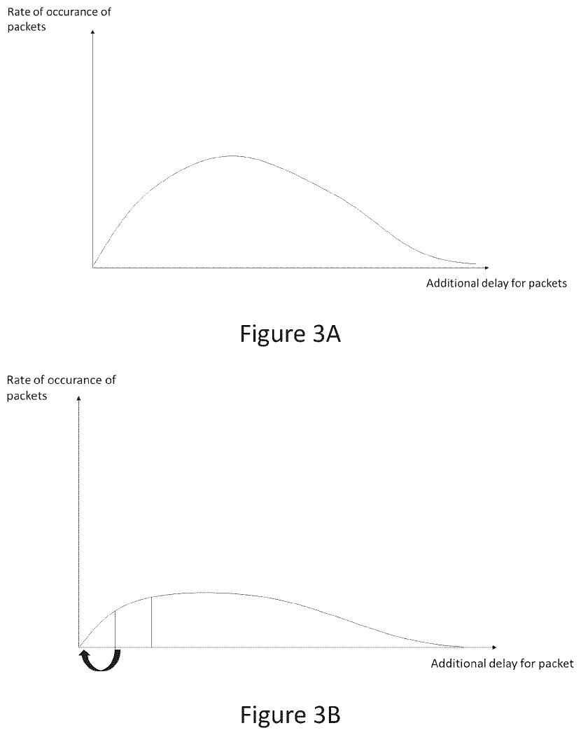

PTP uses an exchange of four timestamps between a reference clock (master port) and the clock to be synchronized (slave port), as illustrated in FIG. 2. The master (60) sends a PTP Sync message (Sync (t1)) containing a timestamp of when the Sync message is transmitted (t1) to the slave (70). In a two-step master clock, the t1 timestamp is sent in a Follow_Up message (Optional follow up (t1)). The slave records the time it receives the Sync message (t2). At some point after receiving the Sync message, the slave sends a Delay_Req message back to the master (Delay_req (t3)). The slave records the time of transmission of the Delay_Req message (t3) locally. The master records the time it receives the Delay_Req message (t4) and sends this timestamp back to the slave in a Delay_Resp message (Delay_Resp (t4)). After the four timestamp exchange the slave can calculate the mean path delay and the clock offset from master using the following two equations:

$$\begin{matrix}mean\_path \_delay = [ ( t 4 - t 1 ) - ( t 3 - t 2 ) ] / 2 \\ offset\_from \_master = [ ( t 2 - t 1 ) - mean\_path \_delay ]\end{matrix}$$

These calculations can occur on every message exchange or some initial packet selection can be performed so that only optimal message exchanges are used. The latter is useful if there is variable delay between the master and slave ports. If only frequency is necessary, then the slave may use one or both pairs of timestamps (t1, t2) and (t3, t4). The slave can monitor the change in the perceived delay master-to-slave (t2−t1) or slave-to-master (t4−t3) over time. If the delay (t2−t1) decreases over time, it means the t2 timestamps are not progressing quickly enough and the slave clock frequency needs to be increased. If time is necessary, then all four timestamps must be used. It is also important to note how the equation for offset uses the mean_path_delay. If the delays in the two directions are actually different, then the equation will introduce an error in the offset_from_master that is half of the difference of the two delays. The IEEE 1588 standard includes procedures to compensate for this asymmetry, if it is known, but if it is uncompensated it does introduce time error.

IEEE 1588 synchronization performance depends on several related factors. Among them, the symmetry of packet delay is the most basic one. But most existing networks could not provide symmetry packet delay between master and slave clocks. The First In First Out (FIFO) principle, which would make some packets transmitted delay, is called FIFO waiting. The uncertainty of FIFO waiting would lead packet delay variation. FIFO waiting during packet transmitting is one of the main reasons that lead the asymmetry. A packet delay estimation algorithm to select “lucky packets”, which survived from FIFO waiting, may improve the accuracy of packet delay estimation.

IEEE 1588 has provided effective solutions to realize high-accuracy synchronization based on network. Following the “delay require-response” principle, the protocol transfers packets periodically to provide precision timestamps for estimating the offset from master-to-slave in IEEE 1588 slave clocks. According to the estimated offset, slave clocks would adjust its local clock through servo system. After several periodical adjustment, slave clocks could achieve synchronization with master clock in the end. The process of IEEE 1588 synchronization could be divided into two steps: clock offset measurement and packet transmission delay measurement. In the process of clock offset measurement, master clock would send synchronization packet “Sync” to slave clock and meanwhile mark the precision leaving time of packet “Sync” as T_{Sync_Tx}. And then, slave clock would mark the precision arriving time of packet “Sync” as T_{Sync_Rx}. Since the leaving time information T_{Sync_Tx} could not be included into the packet “Sync” precisely, IEEE 1588 defines packet “Follow_up” to transmit the leaving time information of packet “Sync” precisely. If we define the packet transmission delay from master to slave as MS_{delay}, and the offset between master and slave as Offset, we can calculate the offset as

$$Offset = {T}_{Synch\_Rx} - {T}_{Synch\_Tx} - {MS}_{delay}$$

The unknown MS_{delay} could be calculated by packet transmission delay measurement. In the process of packet transmission delay measurement, slave clock would firstly send delay requirement packet “Delay_req” to master clock and meanwhile mark its precision leaving time as TDelay_Req_Tx. And then, master clock would mark the precision arriving time of packet “Delay_req” as TDelay_Req_Rx. In the end, master clock would send the arriving time information back to slave clock with packet “Delay_resp”. If we define the packet transmission delay from slave to master as SM_{delay}, then

$${SM}_{delay} = {T}_{Delay\_req \_Rx} - {T}_{Delay\_req \_Tx} + Offset$$

Here, IEEE 1588 has a basic assumption that the packet transmission delay from master to slave is the same as from slave to master, that is to say

$${MS}_{delay} = {SM}_{delay}$$

Based on this assumption, we can get the offset

$$Offset = ( ( {T}_{Synch \_ Rx} - {T}_{Synch \_ Tx} ) - ( {T}_{Delay \_ req \_ Rx} - {T}_{Delay \_ req \_ Tx} ) ) / 2$$

Thus, we can get that the accuracy of estimated offset is nearly related to the symmetry of packet delay. If the assumption that packet delay is symmetry could be met, the estimated offset would reflect the real offset. But if the assumption could not be meet, the synchronization based on estimated offset would be damaged.

Time-based communications is a technology where an active data communications channel is used as a vehicle for two-way time transfer. Precision timing is provided in the background of an active data transfer channel (one that is being used for data communication). This allows two ends of a communications link to be precisely synchronized without fielding an independent timing system. For packed-based transmissions, the impairment of the timing of received packets is mainly due to the packet network that transports them. Upon experiencing poorer performance in view of delay or packet loss, such as timing/synchronization packet loss, a backoff to a lower packet rate may be performed. However, this leads to a lower throughput in the network.

In view of the above identified problem, the object of the present invention is to provide a method allowing for dynamic compensation of increased jitter, such as dynamic traffic load compensation. The current disclosure thus provides solutions to the above-mentioned problems and drawbacks of impaired performance of a packet based network due to heavy traffic, where synchronization/timing packets may be delayed or lost. By dynamically compensating for the increased PDV of increased traffic load, the drawbacks of the prior art may be mitigated.

The theoretical base of the current invention is based on the realization that for a packet-based transmission, for which phase, frequency or time is estimated either using one-way or two-way mechanisms, the impairment of the timing of received packets is due to the packet network that transports them. This network has intrinsic variations due to its realization given no traffic load, and in addition provides a significant timing impairment due to traffic load, impacting the timing of packets both directly and indirectly. An example of direct impairment is adding other packets into packet-buffer, providing a head-of-line blocking causing additional delay for the timing packets. An example of indirect impairment is that traffic affects the scheduling of transmission of packets is affected by processing of other packets. Implementation forms of schedulers, together with traffic and configuration, creates a range of behaviours, all leading to other traffic affecting the actual delay of timing packets.

A simple model to understand these impairments is to consider a transmitter node A generating a stream of packets, each having a time-stamp of the transmission time in some clock of the transmitter node. As these packets is received in a receiver node B, each packet is time-stamped of the reception time, in some clock of the receiver node. As one looks on the difference of these time-stamps for the same packet, one get an estimation of the elapsed time from the transmitter to the receiver node. This estimation will be biased by the time-difference of the two nodes, but for the general discussion we will assumed that this time-difference is zero or static. Further, the basic delay of the empty network will cause a basic delay.

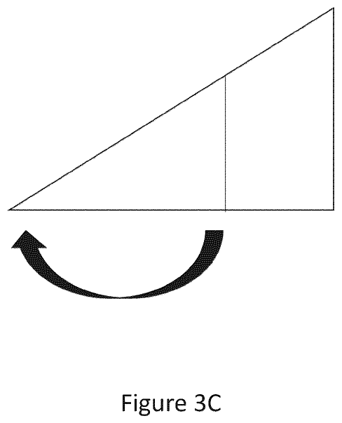

Given a large set of such time-differences, one can analyze them statistically by means of creating a histogram to illustrate the distribution, see FIG. 3A. FIG. 3A depicts a histogram to illustrate the distribution of the time-differences between two nodes formed as a statistical distribution of rate of occurrence for packets (y-axis) for a particular additional delay (x-axis). This distribution can have many different forms, but tends to have a low mean value, while having a long “tail” of low probability for long delays, similar to the curve given. Thus, the curve serve to illustrate one such distribution out of many possible. For the purpose of the invention, the increasing rate of occurrence from the minimum delay is the critical property, as the aim of the minimum processing is to ignore the details of the shape of the remaining curve by just ignoring samples, and thus distribution shape, of those having a larger delay as choosing those having the minimum delay over the block of processing. Thus, by creating a set of bins for a range of values, one count the occurrence of difference samples to be within such a range. The produced histogram will form a statistical distribution. This will have the first occurrence near the minimum delay of the medium.

For classical processing, one use all these time-stamps differences to steer a recovered clock. This provides an estimated time which will be the mean value of the distribution, all assuming same weight to all values. While simple, this have a draw-back since the variations provided by the network creates a huge variation. At the same time, the distribution is not symmetric around mean, as assumed from normal gaussian distribution, it is asymmetric. As variation grows, it does so by having more and more packets experience more delay, thus being further away from the minimum delay. This also shifts the mean value of the packets. As traffic load changes, the distribution changes and thus the mean value changes.

In order to address this, non-linear filtering methods have been employed. Considering that the distribution still has some packets being near the minimum delay, those have higher value for timing than those further away. Thus, by weighing differences differently based on their value, a better value can be chosen, and this is whichever value of two that has lower delay. A number of such packets can be evaluated over a range, and the minimum delay packet is chosen to represent the best measure out of that block. This is from the packet that was lucky enough to go through the network with least impairment, from the given set of packets. This have led to the names of min-delay filtering or lucky packet filtering. It has been shown that such filtering can have significant reduction of variation compared to the unfiltered set of samples.

The result will be a larger set of packets and their distribution will be replaced by a smaller set of packets, sharing the left-hand shape of the larger distribution, as illustrated in FIG. 3B. FIG. 3B is a histogram illustrating the distribution of the packages after min-delay filtering or lucky packet filtering, as illustrated by the lines. In FIG. 3A the shape of the curve is illustrated, while the distribution in 3B illustrates, for one block of packets with the shape in 3A, how to do a selection of the delay of said packets to get a lower value more to the left on the curve. This new distribution depends on the larger distribution depicted in FIG. 3A, but have its own distribution properties, including mean value. As the traffic load change the shape of the large distribution, it will inadvertedly also change the shape of the smaller, and thus the mean value. The more packets that are used in the min-processing, the more packets have a probability of belonging to the left part of the curve, and hence be able to be used as the minimum value of said block. Assuming that the min-processing is done over sufficiently many packets, and their associated time-stamp differences, the smaller distribution will be essentially a rising slope as part of the left-most rising slope of the larger distribution. The vertical lines are introduced in the graph to symbolize this. One is to exemplify if we use e.g. 100 packets for min-processing (the vertical line to the right), and the other if we use e.g. 200 packets (vertical line to the left). Hence, an ability and method to suppress the properties of varying block sizes is attained.

One can approximate the distribution to take the form of a right-angled square as illustrated in FIG. 3C, which base has the length being the minimum and maximum of this range of this longer sequence. It is emphasized that the triangle approximation is an idealized distribution, that an actual right square triangle is not really formed.

It is illustrated how the traffic variations alter the “standard” delay from the position of the arrow, depending on the traffic load, to the vertical lines, where a smaller block size is illustrated as the vertical line to the right, while a larger block size is shown as the left vertical line. Thus, for a larger block size one will increase the probability of achieving a sample (packet) with a lower delay, and hence a decreased spread of min-values between different blocks. Thus, the variations are decreased by using a larger block size, hence identifying the possibility of altering the packet rate or block size depending on the attained variation, since it affects the impact attained from the network. From geometry, we can estimate the mean value based either on the mean of the samples, or from the detected min and max values of the sequence, and then the mean is ⅔ of the length.

Packet delay variations (PDVs) increase the risk of packet loss and hence poorer quality of the transferred information, such as poorer video quality when streaming video. In order to combat packet delay variations, it is important to have a lot of measures into the min-algorithm (lucky packet filtering).

As the traffic load changes, the overall distribution changes and with that the min distribution, the mean value of the min distribution changes. One way to reduce this variation is to increase the size of the block of difference samples, and thereby “clip” the overall distribution further to the left. A factor of two increase of block length will remove half the samples creating the lower distribution seen in FIG. 3B, and this will be the top ⅓ half of samples, above the mean value of the min-distribution for the smaller block-length.

The current invention lies in the realization that the min-distribution can have sufficiently know properties, such that they can be estimated, and the variations as observed from actual data can allow a rough compensation of the mean. Rather than allowing the filter to work on the mean delay, they estimate the adjusted min delay. This can be achieved by monitoring the produced min-distribution and estimate a mean value, and then subtract the samples with that mean value to instead provide a distribution which mean value lies near the minimum delay. As traffic load variations occurs, the estimated average mean value will be closely related to actual mean, but the changes will cause momentary deviations.

The mean of delays of packets in a transmission of a stream of packets between a first and a second node may be used for time or clock recovery. As traffic load changes, PDV grows as the number of packets experiencing more delay increases, hence shifting the mean value, giving a less accurate timing recovery of the recovered clock. To address this, non-linear filtering may be used (e.g. min-filtering), reducing the PDV. However, as the traffic load increases, so does the PDV also for the min distributed packets, and the mean value of the min distribution. This may be addressed by dynamically compensating for the shifted mean value. By estimating the properties of the min-distribution of a transmitted block of packets using the observed variations from the transmitted packets, a min delay may be estimated. The mean delay may be estimated by monitoring the produced min-distribution, estimate a mean value of said distribution, and subtracting said mean from the samples of said distribution to obtain a new distribution. By estimating or calculating the mean of said new distribution, the min delay may be obtained.

Thus, the aim of the present invention is to achieve timing recovery/clock recovery/synchronization when transmitting packets between two nodes in a network or system where the traffic load in the network changes. Increased traffic load increases the delay variance of the packets, and the invention is based on the realization that the mean value of a min distribution of a block of packets, which may normally be used for time recovery, is changed based on the traffic load, and hence when the traffic load is high, the timing recovery/compensation based on the mean of the min distribution may no longer be sufficient. Thus, instead either a mean delay value from a second min distribution may be used, or a calculated rate of change of the mean. In one embodiment, a second min distribution is attained by subtracting the mean value of the first mean distribution from the packet delays, which mean value may then be used for compensation instead. In this way, the increased delay variance attained by the increased traffic load is compensated for. The resulting method is thus an automatic self-regulated dynamic process for achieving a more accurate compensation in a system or network, which takes the traffic load into account, without the need for manual intervention.

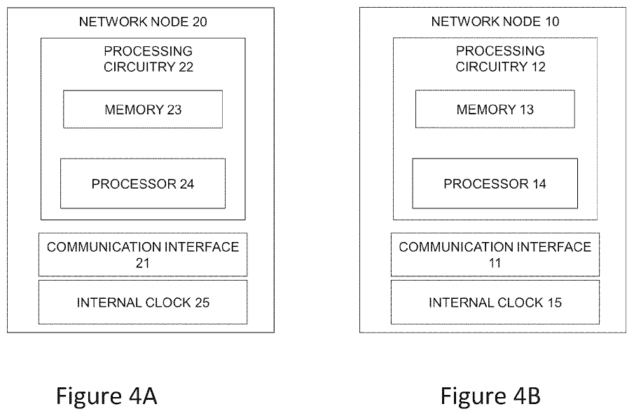

Accordingly, according to the present disclosure, instead of using the mean of the min distribution as a compensation factor, a new compensating factor may be attained. To achieve an enhanced time recovery between a first and a second node, the first and second node being shown in the block diagrams of FIGS. 4A and 4B, the network nodes (20, 10) may communicate with each other using processing circuitry (22, 12) via a communication interface (21, 11), performing time transfers by stamping packets with a transmission and reception time in view of their respective internal clocks (25, 15).

In an example, FIG. 4A illustrates a block diagram of a network node (20) of the invention. The network node comprises a communications interface 21 (e.g. a radio communication interface or radio circuitry or network interface) 21, configured to receive and transmit any form of communications or control signals within a network, e.g. for connecting the node to at least one neighbouring node, such as a master or slave node, and for sending and receiving data over transport links. It should be appreciated that the communication interface (radio circuitry) 21 is according to some aspects comprised as any number of transceiving, receiving, and/or transmitting units or circuitry. It should further be appreciated that the radio circuitry 21 can e.g. be in the form of any input/output communications port known in the art. The radio circuitry 21 may comprise RF circuitry and baseband processing circuitry (not shown).

The node further comprises processing circuitry 22 comprising a memory 23 and a processor 24 being configured to carry out the method of the invention. The node 20 according to some aspects further comprises at least one memory unit or circuitry 23 that is in communication with the radio circuitry 21. The memory 23 can e.g. be configured to store received or transmitted data and/or executable program instructions. The memory 23 is e.g. configured to store any form of contextual data. The memory 23 can e.g. be any suitable type of computer readable memory and can e.g. be of volatile and/or non-volatile type. The memory may for example log received time stamps. The network node 20 further comprises processing circuitry 22 which configured to cause the network node 20 to carry out the methods of the invention.

The processing circuitry 22 is e.g. any suitable type of computation unit, e.g. a microprocessor, Digital Signal Processor, DSP, Field Programmable Gate Array, FPGA, or Application Specific Integrated Circuit, ASIC, or any other form of circuitry. It should be appreciated that the processing circuitry need not be provided as a single unit but is according to some aspects provided as any number of units or circuitry. The processing circuitry may thus comprise both a memory 23 for storing a computer program and a processor 24, the processor being configured to carry out the method of the computer program.

The controller, CTL, or processing circuitry 22 is according to some aspects capable of executing computer program code. The computer program is e.g. stored in a memory, MEM, 23. The memory 23 can be any combination of a Read And write Memory, RAM, and a Read Only Memory, ROM. The memory 23 in some situations also comprise persistent storage, which, for example, can be any single one or combination of magnetic memory, optical memory, or solid state memory or even remotely mounted memory. It should be appreciated that the processing circuitry need not be provided as a single unit but is according to some aspects provided as any number of units or circuitry.

According to some aspects, the disclosure relates to a computer program comprising computer program code which, when executed, causes a network node to execute the methods described above and below.

The node may comprise an internal clock, and may be able to provide and store timestamps in relation to said internal clock, and store time stamps in relation to other nodes. The node may also comprise a GPS/GNSS receiver if being a master node.

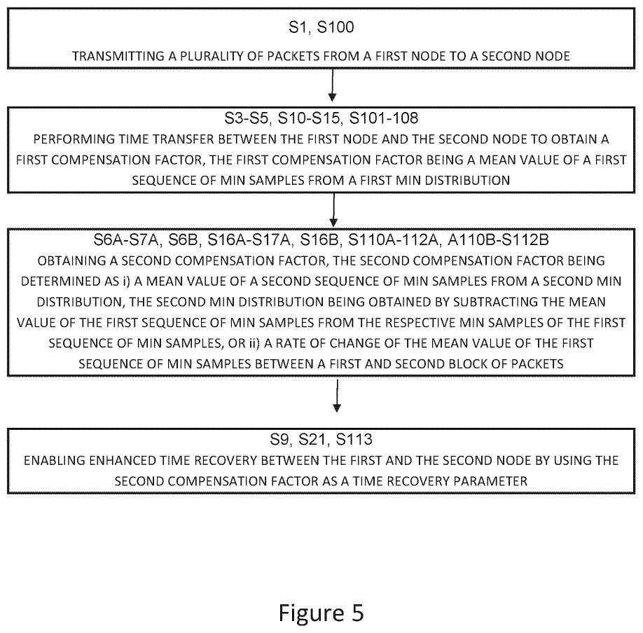

As illustrated in FIG. 5, in one aspect, a method for enabling enhanced time recovery between a first node and a second node in a network, comprises transmitting (S1, S100) a plurality of packets from a first node to a second node, performing (S3-S5, S10-S15, S101-108) time transfer between the first node and the second node to obtain a first compensation factor, the first compensation factor being a mean value of a first sequence of min samples from a first min distribution, obtaining (S6A-S7A, S6B, S16A-S17A, S16B, S110A-112A, A110B-S112B) a second compensation factor, the second compensation factor being determined as i) a mean value of a second sequence of min samples from a second min distribution, the second min distribution being obtained by subtracting the mean value of the first sequence of min samples from the respective min samples of the first sequence of min samples, or ii) a rate of change of the mean value of the first sequence of min samples between a first and second block of packets, wherein the rate of change is calculated as C_rate=(mean2−mean1)/(inter block time), wherein C_rate is the rate of change, mean2 is the mean value of the second block of packets and the mean1 is the mean value of the first block of packets, and inter block time is the time periodicity between the blocks, and enabling (S9, S21, S113) enhanced time recovery between the first and the second node by using the second compensation factor as a time recovery parameter.

Thus, instead of using the first compensation factor, as in the prior art, a new second compensation factor is estimated, which second compensation factor takes the traffic load into account by minimizing its effect on the compensation factor, thus enabling enhanced time recovery, especially during heavy traffic load.

In one detailed embodiment, the mean delay is used for attaining the second compensation factor. A first node sends a plurality of packets to a second node. The second splits the plurality of packets into a sequence of blocks of packets. The packets are timestamped in the first node with a timestamp t1 when transmitted, and timestamped in the second node with a timestamp t2 when received at the second node, the timestamps t1 and t2 being in relation to local clocks in each respective node. Upon reception, the second node also splits the plurality of packets into a sequence of blocks of packets. In the next step, the second node may either transmit the timestamps t2 to the first node, including information regarding how the plurality of packets have been split into blocks, or it may calculate the timestamp differences, t2−t1, to obtain a delay for each packet. In case the first node receives the timestamps t2, the timestamp difference/delay calculation is instead performed in the first node. If the calculations have been performed in the second node, the second node may then transmit the calculated delays for all packets to the first node, or it may perform min processing on each of the blocks of packets to estimate, for each block of packets, a first min distribution of the delays for each packet to obtain a first sequence of min samples. In case the first node calculates or receives the delays, it may instead perform the min processing to obtain the first sequence of min samples. The second node may then estimate a mean value of the first sequence of min samples from the first min distribution, or send information regarding the first sequence of min samples to the first node so that the first node may estimate the mean value. This mean value is normally seen as the “true delay” and used for time recovery, however it is traffic dependent. Thus, to attain a better compensation value for time recovery the additional steps are performed.

The second node may estimate a second min distribution by subtracting the mean value of the first sequence of min samples from the respective min samples of the first sequence of min samples to obtain a second sequence of min samples, or transmit the mean value of the first sequence of min samples to the first node, so that the first node may estimate the second min distribution. The second node may then calculate the mean value of the second sequence of min samples from the second min distribution to obtain a mean delay value, which may then be used for timing recovery. In another embodiment, the second node transmits the second sequence of min samples to the first node, which calculates the mean value of the second sequence of min samples from the second min distribution to obtain a mean delay value. The first node then sends the mean delay value to the second node for time recovery.

In a second detailed embodiment, the rate of change is used for attaining the second compensation factor. Instead of estimating the mean delay value from a second min distribution, a rate of change of the mean value is determined and used for compensation. The rate of change is determined as the difference between the min values of each block divided by time: C_rate=(mean2−mean1)/(inter block time), wherein C_rate is the rate of change, mean2 is the mean value of the second block of packets and the mean1 is the mean value of the first block of packets, and inter block time is the time periodicity between the blocks. In one detailed embodiment, a first node sends a plurality of packets to a second node, the plurality of packets comprising a timestamp t1, the timestamp t1 relating to a time when a respective packet was transmitted in relation to a local clock in the first node, and the second node may split the received plurality of packets into a sequence of blocks of packets and timestamp each of the plurality of packets with a timestamp t2, the timestamp t2 relating to a time when a respective packet was received in relation to a local clock in the second node. The second node may then send traffic load information to the first node, which then transmits to the second node, a time recovery parameter based on the traffic load information for performing time recovery of the local clock of the second node using the time recovery parameter. In one embodiment the traffic load information comprises information relating to how the second node has split the plurality of packets into a sequence of blocks of packets and, for each of the plurality of packets, a timestamp t2, the timestamp t2 relating to a time when a respective packet was received in relation to a local clock in the second node. The first node will then determine the time differences between the timestamps t2 and t1 for each packet in each block of packets to obtain a delay for each packet, perform min processing on each of the blocks of packets to estimate, for each block of packets, a min distribution of the delays for each packet to obtain a sequence of min samples, estimate, for each block of packets, a mean value of the sequence of min samples from the min distribution, and determine the time recovery parameter as a rate of change between the mean values of the different blocks, such as a first block and a second block. The first node then transmits the time recovery parameter to the second node for performing time recovery of the local clock of the second node using the time recovery parameter. In another embodiment, the second node performs the determination of the time differences between the timestamps t2 and t1, and the traffic load information comprises said information. The first node then proceeds with the rest of the steps as above to obtain the time recovery parameter. In another embodiment, the second node performs both the determination of the time differences and the min processing to obtain a sequence of min samples, and the traffic load information comprises said sequence of min samples. The first node then proceeds with the rest of the steps as above to obtain the time recovery parameter. In another embodiment, the second node performs the determination of the time differences, the min processing to obtain a sequence of min samples, and the estimation of a mean value from said sequence of min samples for each block of packets, and the traffic load information comprises said mean values. The first node then determines the time recovery parameter as a rate of change of the mean value between a first and second block of packets, and transmits said time recovery parameter to the second node for enabling performing time recovery of the local clock of the second node.

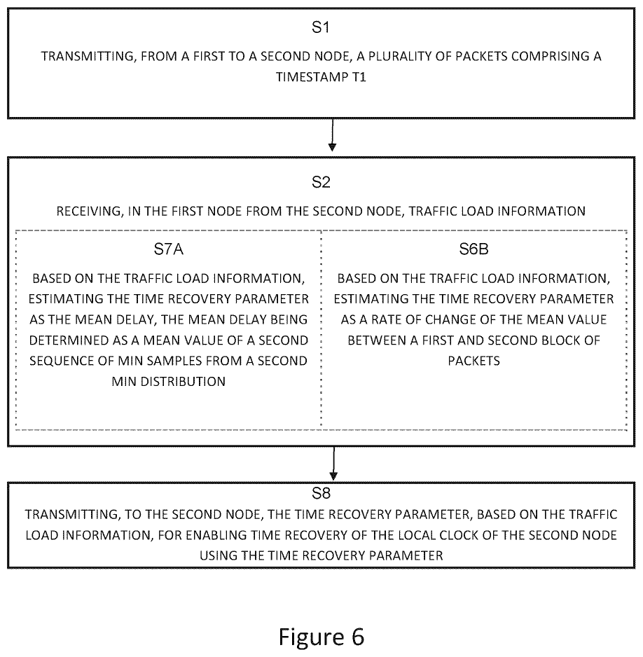

The methods may be seen from the perspective of the respective nodes. As illustrated in FIG. 6, a method for use in a first node for enabling enhanced time recovery between the first node and a second node in a network is shown, the method comprising transmitting (S1), to the second node, a plurality of packets comprising a timestamp t1, the timestamp t1 relating to a time when a respective packet was transmitted in relation to a local clock in the first node, receiving (S2), from the second node, traffic load information, and transmitting (S8), to the second node, a time recovery parameter based on the traffic load information for performing time recovery of the local clock of the second node using the time recovery parameter.

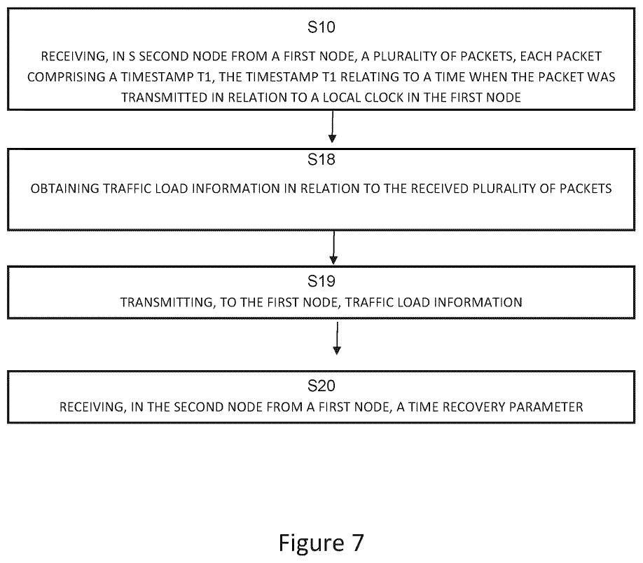

As illustrated in FIG. 7, a method for use in a second node for enabling enhanced time recovery between the first node and a second node in a network is shown, the method comprising receiving (S10), from a first node, a plurality of packets, each packet comprising a timestamp t1, the timestamp t1 relating to a time when the packet was transmitted in relation to a local clock in the first node, (timestamping (S11) each of the received plurality of packets with a timestamp t2, the timestamp t2 relating to a time when a respective packet was received in relation to a local clock in the second node, splitting (S12) the plurality of packets into a sequence of blocks of packets), obtaining (S18) traffic load information in relation to the received plurality of packets, transmitting (S19) traffic load information to the first node, and receiving (S20), from the first node, a time recovery parameter enabling time recovery of the local clock of the second node using a time recovery parameter, the time recovery parameter being received from the first node based on the traffic load information.

Thus, in essence, when performing time transfer and time recovery, such as for synchronizing a second node to a first node, synchronization packets may be sent, however, increased traffic load may increase the delay variation of the packets, giving rise to a poorer performance and synchronization, leading to deteriorated link quality, as increased PDV (jitter) also increases the risk of packet loss. By estimating a mean of the min distribution, and using said mean for compensation of the min distribution, a new min distribution and mean may be obtained, which may be used for time recovery.

In a further embodiment, monitoring of changes in mean can be used to after-compensate using the rate of change in the mean. The compensation method based on the rate of change of the mean of the min distribution may be achieved either through rate of change estimation (first derivative), or through higher system orders (second derivative or higher) in order to compensate such rate-of change deviations.

As a general principle of the present invention, to compensate for jitter of a transmitted block of packets, monitoring of statistical properties of some model shape for the transmitted block is performed, where after compensation of values according to that model is performed, in order to reduce and cancel the packet jitter variations typically related to packet load changes. These changes in properties may also form from changes in configuration, reroutes, firmware upgrades and other events in the network beyond the traffic load.

Thus, the concept of the invention is to dynamically compensate the variation of jitter, caused by e.g. increased traffic load. This may be done by monitoring the change of the mean delay or the rate of the change of the mean, and adjusting the compensation accordingly, for example, by estimating a mean of the min distribution of a transmitted block of packets, or a rate of the change of the mean (between several transmitted blocks), and to use said mean, or rate of mean change to estimate a min delay, to compensate the increase of the mean due to variated jitter. The compensation model thus compensate the increased mean due to jitter, by estimating a compensated mean, which is an estimation of the min delay. By adjusting the compensation based on the dynamic needs, the timing recovery will be enhanced.

In the drawings and specification, there have been disclosed exemplary aspects of the disclosure. However, many variations and modifications can be made to these aspects without substantially departing from the principles of the present disclosure. Thus, the disclosure should be regarded as illustrative rather than restrictive, and not as being limited to the particular aspects discussed above. Accordingly, although specific terms are employed, they are used in a generic and descriptive sense only and not for purposes of limitation.

### Itemized Embodiments

1. A method for use in a first node, for enabling enhanced timing recovery between the first node and a second node in a network, the method comprising:
   transmitting (S1), to the second node, a plurality of packets comprising a timestamp t1, the timestamp t1 relating to a time when a respective packet was transmitted in relation to a local clock in the first node;
   receiving (S2), from the second node, traffic load information; and
   transmitting (S8), to the second node, a time recovery parameter based on the traffic load information for performing time recovery of the local clock of the second node using the time recovery parameter.
2. The method of item 1, wherein the second node has split the plurality of packets into a sequence of blocks of packets and, for each of the plurality of packets, timestamped it with a timestamp t2, the timestamp t2 relating to a time when a respective packet was received in relation to a local clock in the second node, the method further comprising:
   determining (S3) time differences between the timestamps t2 and t1 for each packet in each block of packets to obtain a delay for each packet;
   performing (S4) min processing on each of the blocks of packets to estimate, for each block of packets, a first min distribution of the delays for each packet to obtain a first sequence of min samples;
   estimating (S5) a mean value of the first sequence of min samples from the first min distribution;
   estimating (S6) a second min distribution by subtracting the mean value of the first sequence of min samples from the respective min samples of the first sequence of min samples to obtain a second sequence of min samples; and
   estimating (S7) the time recovery parameter as the mean delay, the mean delay being determined as the mean value of the second sequence of min samples from the second min distribution,
   wherein the steps may be carried out in either one of the first or the second node.
3. The method according to any one of items 1 or 2, wherein the traffic load information comprises i) information relating to how the second node has split the plurality of packets into a sequence of blocks of packets and, for each of the plurality of packets, a timestamp t2, the timestamp t2 relating to a time when a respective packet was received in relation to a local clock in the second node, ii) information relating to how the second node has split the plurality of packets into a sequence of blocks of packets and a delay for each packet of the plurality of packets, wherein the delay for each packet relates to a time difference between timestamps t2 and t1 for each packet in each block of packets, and where the timestamp t2 relates to a time when a respective packet was received in relation to a local clock in the second node, iii) information relating to how the second node has split the plurality of packets into a sequence of blocks of packets and a first sequence of min samples for each block, first sequence of min samples being obtained by min processing on each of the blocks of packets to estimate, for each block of packets, a first min distribution of the delays for each packet, iv) information relating to how the second node has split the plurality of packets into a sequence of blocks of packets, a first sequence of min samples from a first min distribution and a mean value of the first sequence of min samples from a first min distribution, the first sequence of min samples being obtained by min processing on each of the blocks of packets to estimate, for each block of packets, a first min distribution of the delays for each packet, or v) information relating to how the second node has split the plurality of packets into a sequence of blocks of packets and a second sequence of min samples, the second sequence of min samples being estimated by deducting a mean value of a first sequence of min samples from a first min distribution, first sequence of min samples being obtained by min processing on each of the blocks of packets to estimate, for each block of packets, a first min distribution of the delays for each packet.
4. The method of item 2, wherein the method comprises:
   on condition that the received traffic load information comprises information relating to how the second node has split the plurality of packets into a sequence of blocks of packets and, for each of the plurality of packets, a timestamp t2, the timestamp t2 relating to a time when a respective packet was received in relation to a local clock in the second node,
      determining (S3) time differences between the timestamps t2 and t1 for each packet in each block of packets to obtain a delay for each packet;
      performing (S4) min processing on each of the blocks of packets to estimate, for each block of packets, a first min distribution of the delays for each packet to obtain a first sequence of min samples;
      estimating (S5) a mean value of the first sequence of min samples from the first min distribution;
      estimating (S6) a second min distribution by subtracting the mean value of the first sequence of min samples from the respective min samples of the first sequence of min samples to obtain a second sequence of min samples; and
      estimating (S7) the time recovery parameter as the mean delay, the mean delay being determined as the mean value of the second sequence of min samples from the second min distribution.
5. The method of item 2, wherein the method comprises:
   on condition that the received traffic load information comprises information relating to how the second node has split the plurality of packets into a sequence of blocks of packets and a delay for each packet of the plurality of packets, wherein the delay for each packet relates to a time difference between timestamps t2 and t1 for each packet in each block of packets, and where the timestamp t2 relates to a time when a respective packet was received in relation to a local clock in the second node,
      performing (S4) min processing on each of the blocks of packets to estimate, for each block of packets, a first min distribution of the delays for each packet to obtain a first sequence of min samples;
      estimating (S5) a mean value of the first sequence of min samples from the first min distribution;
      estimating (S6) a second min distribution by subtracting the mean value of the first sequence of min samples from the respective min samples of the first sequence of min samples to obtain a second sequence of min samples; and
      estimating (S7) the time recovery parameter as the mean delay, the mean delay being determined as the mean value of the second sequence of min samples from the second min distribution.
6. The method of item 2, wherein the method comprises:
   on condition that the received traffic load information comprises information relating to how the second node has split the plurality of packets into a sequence of blocks of packets and a first sequence of min samples for each block, first sequence of min samples being obtained by min processing on each of the blocks of packets to estimate, for each block of packets, a first min distribution of the delays for each packet,
      estimating (S5) a mean value of the first sequence of min samples from the first min distribution;
      estimating (S6) a second min distribution by subtracting the mean value of the first sequence of min samples from the respective min samples of the first sequence of min samples to obtain a second sequence of min samples; and
      estimating (S7) the time recovery parameter as the mean delay, the mean delay being determined as the mean value of the second sequence of min samples from the second min distribution.
7. The method of item 2, wherein the method comprises:
   on condition that the received traffic load information comprises information relating to how the second node has split the plurality of packets into a sequence of blocks of packets, a first sequence of min samples from a first min distribution and a mean value of the first sequence of min samples from a first min distribution, the first sequence of min samples being obtained by min processing on each of the blocks of packets to estimate, for each block of packets, a first min distribution of the delays for each packet,
      estimating (S6) a second min distribution by subtracting the mean value of the first sequence of min samples from the respective min samples of the first sequence of min samples to obtain a second sequence of min samples; and
      estimating (S7) the time recovery parameter as the mean delay, the mean delay being determined as the mean value of the second sequence of min samples from the second min distribution.
8. The method of item 2, wherein the method comprises:
   on condition that the received traffic load information comprises information relating to how the second node has split the plurality of packets into a sequence of blocks of packets and a second sequence of min samples, the second sequence of min samples being estimated by deducting a mean value of a first sequence of min samples from a first min distribution, first sequence of min samples being obtained by min processing on each of the blocks of packets to estimate, for each block of packets, a first min distribution of the delays for each packet, and
      estimating (S7) the time recovery parameter as the mean delay, the mean delay being determined as the mean value of the second sequence of min samples from the second min distribution.
9. The method according to of item 1, wherein the second node has split the plurality of packets into a sequence of blocks of packets and, for each of the plurality of packets, timestamped it with a timestamp t2, the timestamp t2 relating to a time when a respective packet was received in relation to a local clock in the second node, the method further comprising:
   determining (S3) time differences between the timestamps t2 and t1 for each packet in each block of packets to obtain a delay for each packet;
   performing (S4) min processing on each of the blocks of packets to estimate, for each block of packets, a min distribution of the delays for each packet to obtain a sequence of min samples; and
   estimating (S5), for each block of packets, a mean value of the sequence of min samples from the min distribution; and
   determining (S6) the time recovery parameter as a rate of change of the mean value between a first and second block of packets, wherein the rate of change is calculated as

$$C\_rate = \frac{mean 2 - mean 1}{inter block time} ,$$

wherein C_rate is the rate of change, mean2 is the mean value of the second block of packets and the mean1 is the mean value of the first block of packets, and inter block time is the time periodicity between the blocks,
wherein the steps S3-S5 may be carried out in any one of the first or the second node.
10. The method according to item 9, wherein the method comprises:
   on condition that the received traffic load information comprises information relating to how the second node has split the plurality of packets into a sequence of blocks of packets and, for each of the plurality of packets, a timestamp t2, the timestamp t2 relating to a time when a respective packet was received in relation to a local clock in the second node,
      determining (S3) time differences between the timestamps t2 and t1 for each packet in each block of packets to obtain a delay for each packet;
      performing (S4) min processing on each of the blocks of packets to estimate, for each block of packets, a min distribution of the delays for each packet to obtain a sequence of min samples;
      estimating (S5), for each block of packets, a mean value of the sequence of min samples from the min distribution; and
      determining (S6) the time recovery parameter as a rate of change of the mean value between a first and second block of packets, wherein the rate of change is calculated as

$$C\_rate = \frac{mean 2 - mean 1}{inter block time} ,$$

wherein C_rate is the rate of change, mean2 is the mean value of the second block of packets and the mean1 is the mean value of the first block of packets, and inter block time is the time periodicity between the blocks.
11. The method according to item 9, wherein the method comprises:
   on condition that the received traffic load information comprises information relating to how the second node has split the plurality of packets into a sequence of blocks of packets and a delay for each packet of the plurality of packets, wherein the delay for each packet relates to a time difference between timestamps t2 and t1 for each packet in each block of packets, and where the timestamp t2 relates to a time when a respective packet was received in relation to a local clock in the second node,
      performing (S4) min processing on each of the blocks of packets to estimate, for each block of packets, a first min distribution of the delays for each packet to obtain a first sequence of min samples;
      estimating (S5) a mean value of the first sequence of min samples from the first min distribution; and
      determining (S6) the time recovery parameter as a rate of change of the mean value between a first and second block of packets, wherein the rate of change is calculated as

$$C\_rate = \frac{mean 2 - mean 1}{inter block time} ,$$

wherein C_rate is the rate of change, mean2 is the mean value of the second block of packets and the mean1 is the mean value of the first block of packets, and inter block time is the time periodicity between the blocks.
12. The method according to item 9, wherein the method comprises:
   on condition that the received traffic load information comprises information relating to how the second node has split the plurality of packets into a sequence of blocks of packets and a first sequence of min samples for each block, first sequence of min samples being obtained by min processing on each of the blocks of packets to estimate, for each block of packets, a first min distribution of the delays for each packet,
      estimating (S5) a mean value of the first sequence of min samples from the first min distribution; and
      determining (S6) the time recovery parameter as a rate of change of the mean value between a first and second block of packets, wherein the rate of change is calculated as

$$C\_rate = \frac{mean 2 - mean 1}{inter block time} ,$$

wherein C_rate is the rate of change, mean2 is the mean value of the second block of packets and the mean1 is the mean value of the first block of packets, and inter block time is the time periodicity between the blocks.
13. The method according to item 9, wherein the method comprises:
   on condition that the received traffic load information comprises information relating to how the second node has split the plurality of packets into a sequence of blocks of packets, a first sequence of min samples from a first min distribution and a mean value of the first sequence of min samples from a first min distribution, the first sequence of min samples being obtained by min processing on each of the blocks of packets to estimate, for each block of packets, a first min distribution of the delays for each packet; and
      determining (S6) the time recovery parameter as a rate of change of the mean value between a first and second block of packets, wherein the rate of change is calculated as

$$C\_rate = \frac{mean 2 - mean 1}{inter block time} ,$$

wherein C_rate is the rate of change, mean2 is the mean value of the second block of packets and the mean1 is the mean value of the first block of packets, and inter block time is the time periodicity between the blocks.
14. A method for use in a second node, for enabling timing recovery between a first node and the second node in a network, the method comprising:
   receiving (S10), from a first node, a plurality of packets, each packet comprising a timestamp t1, the timestamp t1 relating to a time when the packet was transmitted in relation to a local clock in the first node;
   timestamping (S11) each of the received plurality of packets with a timestamp t2, the timestamp t2 relating to a time when a respective packet was received in relation to a local clock in the second node,
   splitting (S12) the plurality of packets into a sequence of blocks of packets;
   obtaining (S18) traffic load information in relation to the received plurality of packets; and
   transmitting (S19) traffic load information to the first node;
   receiving (S20), from the first node, a time recovery parameter enabling time recovery of the local clock of the second node using a time recovery parameter, the time recovery parameter being received from the first node based on the traffic load information.
15. The method according to item 14, wherein the method further comprises:
   determining (S13) time differences between the timestamps t2 and t1 for each packet in each block of packets to obtain a delay for each packet;
   performing (S14) min processing on each of the blocks of packets to estimate, for each block of packets, a min distribution of the delays for each packet to obtain a sequence of min samples; and
   estimating (S15), for each block of packets, a mean value of the sequence of min samples from the min distribution;
   estimating (S16) a second min distribution by subtracting the mean value of the first sequence of min samples from the respective min samples of the first sequence of min samples to obtain a second sequence of min samples;
   estimating (S17) a mean delay as the mean value of the second sequence of min samples from the second min distribution,
wherein the steps may be carried out in either one of the first or the second node.
16. The method according to item 14 or 15, wherein the method further comprises:
   on condition that the traffic load information comprises information relating to a sequence of blocks of packets and, for each of the plurality of packets, a timestamp t2,
      transmitting (S19A) traffic load information comprising information relating to how the second node has split the plurality of packets into a sequence of blocks of packets and, for each of the plurality of packets, a timestamp t2, the timestamp t2 relating to a time when a respective packet was received in relation to a local clock in the second node; and
      receiving (S20) a time recovery parameter enabling time recovery of the local clock of the second node using a time recovery parameter, the time recovery parameter being received from the first node based on the traffic load information.
17. The method according to item 14 or 15, wherein the method further comprises:
   on condition that the traffic load information comprises information relating to how the second node has split the plurality of packets into a sequence of blocks of packets and a delay for each packet of the plurality of packets,
      determining (S13) time differences between the timestamps t2 and t1 for each packet in each block of packets to obtain a delay for each packet;
      obtaining (S18) and transmitting (S19B), to the first node, traffic load information comprising information relating to how the second node has split the plurality of packets into a sequence of blocks of packets and a delay for each packet of the plurality of packets, wherein the delay for each packet relates to a time difference between timestamps t2 and t1 for each packet in each block of packets, and where the timestamp t2 relates to a time when a respective packet was received in relation to a local clock in the second node; and
      receiving (S20) a time recovery parameter enabling time recovery of the local clock of the second node using a time recovery parameter, the time recovery parameter being received from the first node based on the traffic load information.
18. The method according to item 14 or 15, wherein the method further comprises:
   on condition that the traffic load information comprises information relating to how the second node has split the plurality of packets into a sequence of blocks of packets and a sequence of min samples for each block,
      determining (S13) time differences between the timestamps t2 and t1 for each packet in each block of packets to obtain a delay for each packet;
      performing (S14) min processing on each of the blocks of packets to estimate, for each block of packets, a min distribution of the delays for each packet to obtain a sequence of min samples;
      obtaining (S18) and transmitting (S19C), to the first node, traffic load information comprising information relating to how the second node has split the plurality of packets into a sequence of blocks of packets and a sequence of min samples for each block; and
      receiving (S20) a time recovery parameter enabling time recovery of the local clock of the second node using a time recovery parameter, the time recovery parameter being received from the first node based on the traffic load information.
19. The method according to item 14, wherein the method further comprises:
   on condition that the traffic load information comprises information relating to how the second node has split the plurality of packets into a sequence of blocks of packets and a mean value of a sequence of min samples for each block,
      determining (S13) time differences between the timestamps t2 and t1 for each packet in each block of packets to obtain a delay for each packet;
      performing (S14) min processing on each of the blocks of packets to estimate, for each block of packets, a min distribution of the delays for each packet to obtain a sequence of min samples;
      estimating (S15), for each block of packets, a mean value of the sequence of min samples from the min distribution;
      obtaining (S18) and transmitting (S19D), to the first node, traffic load information comprising information relating to how the second node has split the plurality of packets into a sequence of blocks of packets and a mean value of a sequence of min samples for each block; and
      receiving (S20) a time recovery parameter enabling time recovery of the local clock of the second node using a time recovery parameter, the time recovery parameter being received from the first node based on the traffic load information.
20. The method according to items 14-19, wherein the method further comprises:
   performing (S21) time recovery of the local clock of the second node using the time recovery parameter.
21. The method according to item 14, wherein the method further comprises:
   determining (S13) time differences between the timestamps t2 and t1 for each packet in each block of packets to obtain a delay for each packet;
   performing (S14) min processing on each of the blocks of packets to estimate, for each block of packets, a min distribution of the delays for each packet to obtain a sequence of min samples; and
   estimating (S15), for each block of packets, a mean value of the sequence of min samples from the min distribution;
   determining (S16B) a rate of change of the mean value between a first and second block of packets, wherein the rate of change is calculated as

$$C\_rate = \frac{mean 2 - mean 1}{inter block time} ,$$

wherein C_rate is the rate of change, mean2 is the mean value of the second block of packets and the mean1 is the mean value of the first block of packets, and inter block time is the time periodicity between the blocks.
wherein the steps may be carried out in any one of the first or the second node.
22. The method according to item 14 or 21, wherein the method further comprises:
   on condition that the traffic load information comprises information relating to a time recovery parameter,
      determining (S13) time differences between the timestamps t2 and t1 for each packet in each block of packets to obtain a delay for each packet;
      performing (S14) min processing on each of the blocks of packets to estimate, for each block of packets, a min distribution of the delays for each packet to obtain a sequence of min samples; and
      estimating (S15), for each block of packets, a mean value of the sequence of min samples from the min distribution;
      determining (S16) a rate of change of the mean value between a first and second block of packets, wherein the rate of change is calculated as

$$C\_rate = \frac{mean 2 - mean 1}{inter block time} ,$$

mean value of the second block of packets and the mean1 is the mean value of the first block of packets, and inter block time is the time periodicity between the blocks; and
obtaining (S18) traffic load information comprising a time recovery parameter by determining the time recovery parameter as the determined rate of change.
23. A first node (20), comprising processing circuitry (22) configured to enable timing recovery between the first node and a second node in a network (100), the node (20) comprising:
   a communication interface (21);
   an internal clock (25);
   processing circuitry (22) including a memory (23) and processor (24) configured to cause the node (20) to carry out the method according to any one of items 1-13.
24. A second node (10), comprising processing circuitry (12) configured to enable timing recovery between a first node and the second node in a network (100), the node (10) comprising:
   a communication interface (11);
   an internal clock (15);
   processing circuitry (12) including a memory (13) and processor (14) configured to cause the node (10) to carry out the method according to any one of items 14-22.
25. The node according to items 20 or 21, wherein the node is a network node such as a mux, router or switch or a compute node such as a server or host computer performing synchronization functions, including acting slave to a sync master, boundary clock, transparent clock or a grandmaster.
26. A method for enabling enhanced time recovery between a first node and a second node in a network, the method comprising:
   transmitting (S100), from the first node to the second node, a plurality of packets comprising a timestamp t1, the timestamp t1 relating to a time when a respective packet was transmitted in relation to a local clock in the first node;
   timestamping (S101), in the second node, each of the received plurality of packets with a timestamp t2, the timestamp t2 relating to a time when a respective packet was received in relation to a local clock in the second node;
   splitting (S102) the plurality of packets into a sequence of blocks of packets;
   optionally transmitting (S103) traffic load information relating to how the second node has split the plurality of packets into a sequence of blocks of packets and, for each of the plurality of packets, a timestamp t2, the timestamp t2 relating to a time when a respective packet was received in relation to a local clock in the second node;
   determining (S104), in the first or second node, time differences between the timestamps t2 and t1 for each packet in each block of packets to obtain a delay for each packet;
   on condition that the determining of the time differences has been carried out in the second node,
   optionally transmitting (S105) traffic load information relating to how the second node has split the plurality of packets into a sequence of blocks of packets and a delay for each packet of the plurality of packets, wherein the delay for each packet relates to a time difference between timestamps t2 and t1 for each packet in each block of packets, and where the timestamp t2 relates to a time when a respective packet was received in relation to a local clock in the second node;
   performing (S106), in the first or second node, min processing on each of the blocks of packets to estimate, for each block of packets, a first min distribution of the delays for each packet to obtain a first sequence of min samples;
   on condition that the min processing has been performed in the second node,
   optionally transmitting (S107) traffic load information relating to how the second node has split the plurality of packets into a sequence of blocks of packets and a first sequence of min samples for each block, first sequence of min samples being obtained by min processing on each of the blocks of packets to estimate, for each block of packets, a first min distribution of the delays for each packet;
   estimating (S108), in the first or second node, a mean value of the first sequence of min samples from the first min distribution;
   on condition that the estimation has been performed in the second node,
   optionally transmitting (S109) traffic load information relating to how the second node has split the plurality of packets into a sequence of blocks of packets, a first sequence of min samples from a first min distribution and a mean value of the first sequence of min samples from a first min distribution, the first sequence of min samples being obtained by min processing on each of the blocks of packets to estimate, for each block of packets, a first min distribution of the delays for each packet;
   estimating (S110A), in the first or second node, a second min distribution by subtracting the mean value of the first sequence of min samples from the respective min samples of the first sequence of min samples to obtain a second sequence of min samples;
   on condition that the estimation has been performed in the second node,
   optionally transmitting (S111A) traffic load information relating to how the second node has split the plurality of packets into a sequence of blocks of packets and a second sequence of min samples, the second sequence of min samples being estimated by deducting a mean value of a first sequence of min samples from a first min distribution, first sequence of min samples being obtained by min processing on each of the blocks of packets to estimate, for each block of packets, a first min distribution of the delays for each packet; and
   estimating (S112A), in the first node, the time recovery parameter as the mean delay, the mean delay being determined as the mean value of the second sequence of min samples from the second min distribution,
   transmitting (S113), from the first node to the second node, a time recovery parameter based on the traffic load information for performing time recovery of the local clock of the second node using the time recovery parameter.
27. A method for enabling enhanced time recovery between a first node and a second node in a network, the method comprising:
   transmitting (S100), from the first node to the second node, a plurality of packets comprising a timestamp t1, the timestamp t1 relating to a time when a respective packet was transmitted in relation to a local clock in the first node;
   timestamping (S101), in the second node, each of the received plurality of packets with a timestamp t2, the timestamp t2 relating to a time when a respective packet was received in relation to a local clock in the second node;
   splitting (S102) the plurality of packets into a sequence of blocks of packets;
   optionally transmitting (S103) traffic load information relating to how the second node has split the plurality of packets into a sequence of blocks of packets and, for each of the plurality of packets, a timestamp t2, the timestamp t2 relating to a time when a respective packet was received in relation to a local clock in the second node;
   determining (S104), in the first or second node, time differences between the timestamps t2 and t1 for each packet in each block of packets to obtain a delay for each packet;
   on condition that the determining of the time differences has been carried out in the second node,
   optionally transmitting (S105) traffic load information relating to how the second node has split the plurality of packets into a sequence of blocks of packets and a delay for each packet of the plurality of packets, wherein the delay for each packet relates to a time difference between timestamps t2 and t1 for each packet in each block of packets, and where the timestamp t2 relates to a time when a respective packet was received in relation to a local clock in the second node;
   performing (S106), in the first or second node, min processing on each of the blocks of packets to estimate, for each block of packets, a first min distribution of the delays for each packet to obtain a first sequence of min samples;
   on condition that the min processing has been performed in the second node,
   optionally transmitting (S107) traffic load information relating to how the second node has split the plurality of packets into a sequence of blocks of packets and a first sequence of min samples for each block, first sequence of min samples being obtained by min processing on each of the blocks of packets to estimate, for each block of packets, a first min distribution of the delays for each packet;
   estimating (S108), in the first or second node, a mean value of the first sequence of min samples from the first min distribution;
   on condition that the estimation has been performed in the second node,
optionally transmitting (S109) traffic load information relating to how the second node has split the plurality of packets into a sequence of blocks of packets, a first sequence of min samples from a first min distribution and a mean value of the first sequence of min samples from a first min distribution, the first sequence of min samples being obtained by min processing on each of the blocks of packets to estimate, for each block of packets, a first min distribution of the delays for each packet;
   determining (S110B), in the first or second node, a rate of change of the mean value between a first and second block of packets, wherein the rate of change is calculated

$$C\_rate = \frac{mean 2 - mean 1}{inter block time} ,$$

as wherein C_rate is the rate of change, mean2 is the mean value of the second block of packets and the mean1 is the mean value of the first block of packets, and inter block time is the time periodicity between the blocks;
on condition that the determination has been performed in the second node, optionally transmitting (S111B) traffic load information relating to the determined rate of change; and
estimating (S112B), in the first node, the time recovery parameter as the determined rate of change,
transmitting (S113), from the first node to the second node, the time recovery parameter for enabling time recovery of the local clock of the second node using the time recovery parameter.
28. The method according to items 27 or 28, further comprising:
   performing (S114) timing recovery in the second node based on the received time recovery parameter.
29. A method for enabling enhanced time recovery between a first node and a second node in a network, the method comprising:
   transmitting (S1, S100) a plurality of packets from a first node to a second node;
   performing (S3-S5, S10-S15, S101-108) time transfer between the first node and the second node to obtain a first compensation factor, the first compensation factor being a mean value of a first sequence of min samples from a first min distribution;
   obtaining (S6A-S7A, S6B, S16A-S17A, S16B, S110A-112A, A110B-S112B) a second compensation factor, the second compensation factor being determined as i) a mean value of a second sequence of min samples from a second min distribution, the second min distribution being obtained by subtracting the mean value of the first sequence of min samples from the respective min samples of the first sequence of min samples, or ii) a rate of change of the mean value of the first sequence of min samples between a first and second block of packets, wherein the rate of change is calculated as

$$C\_rate = \frac{mean 2 - mean 1}{inter block time} ,$$

mean value of the second block of packets and the mean1 is the mean value of the first block of packets, and inter block time is the time periodicity between the blocks; and
enabling (S9, S21, S113) enhanced time recovery between the first and the second node by using the second compensation factor as a time recovery parameter.

1. A method for enabling enhanced timing recovery between a first node and a second node in a network, the method comprising:
transmitting a plurality of packets from a first node to a second node;
performing time transfer between the first node and the second node to obtain a first compensation factor, the first compensation factor being a mean value of a first sequence of min samples from a first min distribution, the first sequence of min samples being obtained from an estimated first min distribution of the delays obtained by the min processing on each of the blocks of packets for each block of packets, wherein min processing selects a packet from each block having a lowest delay as a min sample of sample of said block and wherein the min samples of all blocks in the sequence of blocks form a sequence of min samples;
obtaining a second compensation factor, the second compensation factor being determined as i) a mean value of a second sequence of min samples from a second min distribution, the second min distribution being obtained by subtracting the mean value of the first sequence of min samples from the respective min samples of the first sequence of min samples, or ii) a rate of change of the mean value of the first sequence of min samples between a first and second block of packets, wherein the rate of change is calculated as
$$C\_rate = \frac{mean 2 - mean 1}{inter block time} ,$$
wherein C_rate is the rate of change, mean2 is the mean value of the second block of packets and the mean1 is the mean value of the first block of packets, and inter block time is the time periodicity between the blocks; and
enabling enhanced timing recovery between the first and the second node by using the second compensation factor as a time recovery parameter.

2. A method for use in a first node, for enabling enhanced timing recovery between the first node and a second node in a network, the method comprising:
transmitting, to the second node, a plurality of packets comprising a timestamp t1, the timestamp t1 relating to a time when a respective packet was transmitted in relation to a local clock in the first node;
receiving, from the second node, traffic load information;
transmitting, to the second node, a time recovery parameter based on the traffic load information for enabling timing recovery of the local clock of the second node using the time recovery parameter.

3. The method according to claim 2, wherein the second node has split the plurality of packets into a sequence of blocks of packets and, for each of the plurality of packets, timestamped it with a timestamp t2, the timestamp t2 relating to a time when a respective packet was received in relation to a local clock in the second node, the method further comprising:
determining time differences between the timestamps t2 and t1 for each packet in each block of packets to obtain a delay for each packet;
performing min processing on each of the blocks of packets to estimate, for each block of packets, a first min distribution of the delays for each packet to obtain a first sequence of min samples, wherein min processing selects a packet from each block having a lowest delay as a min sample of said block and wherein the min samples of all blocks in the sequence of blocks form a sequence of min samples;
estimating a mean value of the first sequence of min samples from the first min distribution;
estimating a second min distribution by subtracting the mean value of the first sequence of min samples from the respective min samples of the first sequence of min samples to obtain a second sequence of min samples; and
estimating the time recovery parameter as the mean delay, the mean delay being determined as the mean value of the second sequence of min samples from the second min distribution,
wherein the steps S3A-S6A may be carried out in any one of the first or the second node.

4. The method according to claim 2, wherein the traffic load information comprises i) information relating to how the second node has split the plurality of packets into a sequence of blocks of packets and, for each of the plurality of packets, a timestamp t2, the timestamp t2 relating to a time when a respective packet was received in relation to a local clock in the second node, ii) information relating to how the second node has split the plurality of packets into a sequence of blocks of packets and a delay for each packet of the plurality of packets, wherein the delay for each packet relates to a time difference between timestamps t2 and t1 for each packet in each block of packets, and where the timestamp t2 relates to a time when a respective packet was received in relation to a local clock in the second node, iii) information relating to how the second node has split the plurality of packets into a sequence of blocks of packets and a first sequence of min samples for each block, first sequence of min samples being obtained by min processing on each of the blocks of packets to estimate, for each block of packets, a first min distribution of the delays for each packet, iv) information relating to how the second node has split the plurality of packets into a sequence of blocks of packets, a first sequence of min samples from a first min distribution and a mean value of the first sequence of min samples from a first min distribution, the first sequence of min samples being obtained by min processing on each of the blocks of packets to estimate, for each block of packets, a first min distribution of the delays for each packet, or v) information relating to how the second node has split the plurality of packets into a sequence of blocks of packets and a second sequence of min samples, the second sequence of min samples being estimated by deducting a mean value of a first sequence of min samples from a first min distribution, first sequence of min samples being obtained by min processing on each of the blocks of packets to estimate, for each block of packets, a first min distribution of the delays for each packet.

5. The method according to claim 2, wherein the method comprises:
on condition that the received traffic load information comprises information relating to how the second node has split the plurality of packets into a sequence of blocks of packets, a first sequence of min samples from a first min distribution and a mean value of the first sequence of min samples from a first min distribution, the first sequence of min samples being obtained by min processing on each of the blocks of packets to estimate, for each block of packets, a first min distribution of the delays for each packet,
estimating a second min distribution by subtracting the mean value of the first sequence of min samples from the respective min samples of the first sequence of min samples to obtain a second sequence of min samples; and
estimating the time recovery parameter as the mean delay, the mean delay being determined as the mean value of the second sequence of min samples from the second min distribution.

6. The method according to claim 2, wherein the method comprises:
on condition that the received traffic load information comprises information relating to how the second node has split the plurality of packets into a sequence of blocks of packets and a second sequence of min samples, the second sequence of min samples being estimated by deducting a mean value of a first sequence of min samples from a first min distribution, first sequence of min samples being obtained by min processing on each of the blocks of packets to estimate, for each block of packets, a first min distribution of the delays for each packet, and
estimating the time recovery parameter as the mean delay, the mean delay being determined as the mean value of the second sequence of min samples from the second min distribution.

7. The method of claim 2, wherein the second node has split the plurality of packets into a sequence of blocks of packets and, for each of the plurality of packets, timestamped it with a timestamp t2, the timestamp t2 relating to a time when a respective packet was received in relation to a local clock in the second node, the method further comprising:
determining time differences between the timestamps t2 and t1 for each packet in each block of packets to obtain a delay for each packet;
performing min processing on each of the blocks of packets to estimate, for each block of packets, a min distribution of the delays for each packet to obtain a sequence of min samples; and
estimating, for each block of packets, a mean value of the sequence of min samples from the min distribution; and
determining the time recovery parameter as a rate of change of the mean value between a first and second block of packets, wherein the rate of change is calculated as
$$C\_rate = \frac{mean 2 - mean 1}{inter block time} ,$$
wherein C_rate is the rate of change, mean2 is the mean value of the second block of packets and the mean1 is the mean value of the first block of packets, and inter block time is the time periodicity between the blocks,
wherein the steps S3-S5 may be carried out in any one of the first or the second node.

8. A method for use in a second node, for enabling enhanced timing recovery between a first node and the second node in a network, the method comprising:
receiving, from a first node, a plurality of packets, each packet comprising a timestamp t1, the timestamp t1 relating to a time when the packet was transmitted in relation to a local clock in the first node;
timestamping each of the received plurality of packets with a timestamp t2, the timestamp t2 relating to a time when a respective packet was received in relation to a local clock in the second node;
splitting the plurality of packets into a sequence of blocks of packets;
obtaining traffic load information in relation to the received plurality of packets;
transmitting traffic load information to the first node; and
receiving, from the first node, a time recovery parameter enabling timing recovery of the local clock of the second node using a time recovery parameter, the time recovery parameter being received from the first node based on the traffic load information.

9. The method according to claim 8, wherein the method further comprises:
determining time differences between the timestamps t2 and t1 for each packet in each block of packets to obtain a delay for each packet;
performing min processing on each of the blocks of packets to estimate, for each block of packets, a min distribution of the delays for each packet to obtain a sequence of min samples; and
estimating, for each block of packets, a mean value of the sequence of min samples from the min distribution;
estimating a second min distribution by subtracting the mean value of the first sequence of min samples from the respective min samples of the first sequence of min samples to obtain a second sequence of min samples;
estimating a mean delay as the mean value of the second sequence of min samples from the second min distribution,
wherein the steps may be carried out in either one of the first or the second node.

10. The method according to claim 8, wherein the method further comprises:
determining time differences between the timestamps t2 and t1 for each packet in each block of packets to obtain a delay for each packet;
performing min processing on each of the blocks of packets to estimate, for each block of packets, a min distribution of the delays for each packet to obtain a sequence of min samples; and
estimating, for each block of packets, a mean value of the sequence of min samples from the min distribution;
determining a rate of change of the mean value between a first and second block of packets, wherein the rate of change is calculated as
$$C\_rate = \frac{mean 2 - mean 1}{inter block time} ,$$
wherein C_rate is the rate of change, mean2 is the mean value of the second block of packets and the mean1 is the mean value of the first block of packets, and inter block time is the time periodicity between the blocks;
obtaining traffic load information comprising the time recovery parameter by determining the time recovery parameter as the determined rate of change; and
receiving the time recovery parameter enabling timing recovery of the local clock of the second node using the time recovery parameter, the time recovery parameter being received from the first node based on the traffic load information,
wherein the steps S13-S16 may be carried out in any one of the first or the second node.

11. A first node, comprising processing circuitry configured to enable timing recovery between the first node and a second node in a network, the node comprising:
a communication interface;
an internal clock;
processing circuitry including a memory and processor configured to cause the node to carry out the method according to claim 2.

12. A second node, comprising processing circuitry configured to enable timing recovery between a first node and the second node in a network, the node comprising:
a communication interface;
an internal clock;
processing circuitry including a memory and processor configured to cause the node to carry out the method according to any claim 8.

13. The method according to claim 1, the method comprising:
transmitting, from the first node to the second node, a plurality of packets comprising a timestamp t1, the timestamp t1 relating to a time when a respective packet was transmitted in relation to a local clock in the first node;
timestamping, in the second node, each of the received plurality of packets with a timestamp t2, the timestamp t2 relating to a time when a respective packet was received in relation to a local clock in the second node;
splitting the plurality of packets into a sequence of blocks of packets;
optionally transmitting traffic load information relating to how the second node has split the plurality of packets into a sequence of blocks of packets and, for each of the plurality of packets, a timestamp t2, the timestamp t2 relating to a time when a respective packet was received in relation to a local clock in the second node;
determining, in the first or second node, time differences between the timestamps t2 and t1 for each packet in each block of packets to obtain a delay for each packet;
on condition that the determining of the time differences has been carried out in the second node,
optionally transmitting traffic load information relating to how the second node has split the plurality of packets into a sequence of blocks of packets and a delay for each packet of the plurality of packets, wherein the delay for each packet relates to a time difference between timestamps t2 and t1 for each packet in each block of packets, and where the timestamp t2 relates to a time when a respective packet was received in relation to a local clock in the second node;
performing, in the first or second node, min processing on each of the blocks of packets to estimate, for each block of packets, a first min distribution of the delays for each packet to obtain a first sequence of min samples;
on condition that the min processing has been performed in the second node,
optionally transmitting traffic load information relating to how the second node has split the plurality of packets into a sequence of blocks of packets and a first sequence of min samples for each block, first sequence of min samples being obtained by min processing on each of the blocks of packets to estimate, for each block of packets, a first min distribution of the delays for each packet;
estimating, in the first or second node, a mean value of the first sequence of min samples from the first min distribution;
on condition that the estimation has been performed in the second node,
optionally transmitting traffic load information relating to how the second node has split the plurality of packets into a sequence of blocks of packets, a first sequence of min samples from a first min distribution and a mean value of the first sequence of min samples from a first min distribution, the first sequence of min samples being obtained by min processing on each of the blocks of packets to estimate, for each block of packets, a first min distribution of the delays for each packet;
estimating, in the first or second node, a second min distribution by subtracting the mean value of the first sequence of min samples from the respective min samples of the first sequence of min samples to obtain a second sequence of min samples;
on condition that the estimation has been performed in the second node,
optionally transmitting traffic load information relating to how the second node has split the plurality of packets into a sequence of blocks of packets and a second sequence of min samples, the second sequence of min samples being estimated by deducting a mean value of a first sequence of min samples from a first min distribution, first sequence of min samples being obtained by min processing on each of the blocks of packets to estimate, for each block of packets, a first min distribution of the delays for each packet; and
estimating, in the first node, the time recovery parameter as the mean delay, the mean delay being determined as the mean value of the second sequence of min samples from the second min distribution,
transmitting, from the first node to the second node, a time recovery parameter based on the traffic load information for enabling timing recovery of the local clock of the second node using the time recovery parameter.

14. The method according to claim 1, the method comprising:
transmitting, from the first node to the second node, a plurality of packets comprising a timestamp t1, the timestamp t1 relating to a time when a respective packet was transmitted in relation to a local clock in the first node;
timestamping, in the second node, each of the received plurality of packets with a timestamp t2, the timestamp t2 relating to a time when a respective packet was received in relation to a local clock in the second node;
splitting the plurality of packets into a sequence of blocks of packets;
optionally transmitting traffic load information relating to how the second node has split the plurality of packets into a sequence of blocks of packets and, for each of the plurality of packets, a timestamp t2, the timestamp t2 relating to a time when a respective packet was received in relation to a local clock in the second node;
determining, in the first or second node, time differences between the timestamps t2 and t1 for each packet in each block of packets to obtain a delay for each packet;
on condition that the determining of the time differences has been carried out in the second node,
optionally transmitting traffic load information relating to how the second node has split the plurality of packets into a sequence of blocks of packets and a delay for each packet of the plurality of packets, wherein the delay for each packet relates to a time difference between timestamps t2 and t1 for each packet in each block of packets, and where the timestamp t2 relates to a time when a respective packet was received in relation to a local clock in the second node;
performing, in the first or second node, min processing on each of the blocks of packets to estimate, for each block of packets, a first min distribution of the delays for each packet to obtain a first sequence of min samples;
on condition that the min processing has been performed in the second node,
optionally transmitting traffic load information relating to how the second node has split the plurality of packets into a sequence of blocks of packets and a first sequence of min samples for each block, first sequence of min samples being obtained by min processing on each of the blocks of packets to estimate, for each block of packets, a first min distribution of the delays for each packet;
estimating, in the first or second node, a mean value of the first sequence of min samples from the first min distribution;
on condition that the estimation has been performed in the second node,
optionally transmitting traffic load information relating to how the second node has split the plurality of packets into a sequence of blocks of packets, a first sequence of min samples from a first min distribution and a mean value of the first sequence of min samples from a first min distribution, the first sequence of min samples being obtained by min processing on each of the blocks of packets to estimate, for each block of packets, a first min distribution of the delays for each packet;
determining, in the first or second node, a rate of change of the mean value between a first and second block of packets, wherein the rate of change is calculated as
$$C\_rate = \frac{mean 2 - mean 1}{inter block time} ,$$
wherein C_rate is the rate of change, mean2 is the mean value of the second block of packets and the mean1 is the mean value of the first block of packets, and inter block time is the time periodicity between the blocks;
on condition that the determination has been performed in the second node, optionally transmitting traffic load information relating to the determined rate of change; and
estimating, in the first node, the time recovery parameter as the determined rate of change,
transmitting, from the first node to the second node, the time recovery parameter for enabling timing recovery of the local clock of the second node using the time recovery parameter.
